(19) United States
(12) Patent Application Publication
(10) Pub. No.: US 2013/0021548 A1
(43) Pub. Date: Jan. 24, 2013

(54) LIQUID CRYSTAL DISPLAY AND METHOD FOR DRIVING THE SAME THEREOF

(71) Applicants: Li-Wei Sung, Miao-Li County (TW); Ya-Yu Li, Miao-Li County (TW)

(72) Inventors: Li-Wei Sung, Miao-Li County (TW); Ya-Yu Li, Miao-Li County (TW)

(73) Assignees: CHIMEI INNOLUX CORPORATION, Miao-Li County (TW); INNOCOM TECHNOLOGY(SHENZHEN)CO., LTD., Longhua Town (CN)

(21) Appl. No.: 13/478,992

(22) Filed: May 23, 2012

(30) Foreign Application Priority Data
Jul. 19, 2011 (TW) 100125530

(51) Int. Cl. G02F 1/136

(52) U.S. Cl. 349/41

(57) ABSTRACT

A liquid crystal display including a plurality of scan lines, a plurality of data lines and a pixel array is provided. Each data line has a plurality of first vertical portions, a plurality of second vertical portions and a plurality of horizontal portions. The first vertical portions and the second vertical portions are perpendicular to the scan lines. The horizontal portions are parallel to the scan lines. The first vertical portion and the second vertical portion are alternately arranged. Each first vertical portion is connected to its neighboring second vertical portion by a horizontal portion. The pixel array includes a plurality of pixel units. The length of each horizontal portion is equal to the width of at least one pixel unit. The signals with opposite polarities are received by the pixel units on two sides of each horizontal portion.

This application claims the benefit of Taiwan application Serial No. 100125530, filed Jul. 19, 2011, the subject matter of which is incorporated herein by reference.

### BACKGROUND OF THE INVENTION

1. Field of the Invention

The invention relates in general to liquid crystal display (LCD) and a display method thereof, and more particularly to a LCD and a display method thereof which achieve higher display quality with low power consumption.

2. Description of the Related Art

The liquid crystal display (LCD) controls the transmittance of liquid crystal molecules by providing an electrical field to liquid crystal molecules. When a fixed voltage level is provided to liquid crystal molecules, the characteristics of liquid crystal molecules will be damaged such that the response rate of liquid crystal molecules will be retarded when switching the tilt angles of liquid crystal molecules. In the end, blurring and frame flickering will occur to the display image. Therefore, liquid crystal molecules are driven by an AC power typically. That is, positive and negative driving voltages relative to the voltage of common electrode are alternately provided for performing column driving on liquid crystal molecules to avoid the above mentioned problems.

Referring to FIG. 1, a schematic diagram of a liquid crystal display frame mode driven by way of column inversion is shown. In the current technologies, the column inversion driving method is an AC driving method for driving a LCD The pixel units of the same vertical line are driven by the driving voltages with the same polarity, and the pixel units on two neighboring vertical lines are driven by the driving voltages with opposite polarities. Since the pixel units on the same vertical line correspond to the driving voltages with the same polarity, the corresponding driving voltages of the pixel units on the same vertical line may easily interfere with each other through parasitic capacitors and result in the problems such as vertical crosstalk and flickering.

Referring to FIG. 2, a schematic diagram of a liquid crystal display frame mode driven by way of two-line inversion is shown. The two-line inversion driving method is another AC driving method for driving a LCD. In comparison to the column inversion driving method, the two-line inversion driving method resolves the problems of vertical crosstalk and flickering images and provides higher display quality. However, since the data lines require higher frequencies of variation for providing signals, more power is consumed in the two-line inversion driving method than in the column inversion driving method.

Therefore, how to use lower power consumption driving method to provide higher display quality has become a prominent task in the development of LCD.

### SUMMARY OF THE INVENTION

The invention is directed to a liquid crystal display (LCD) and a display method thereof. In comparison to the conventional LCD, the LCD and the display method thereof of the invention effectively resolve the problems of vertical crosstalk and flickering images, and have the advantage of achieving higher frame display quality with lower power consumption.

According to a first aspect of the present invention, a LCD including a plurality of scan lines, a plurality of data lines and a pixel array is provided. Each data line has a plurality of first vertical portions, a plurality of second vertical portions and a plurality of horizontal portions. The first vertical portions and the second vertical portions are substantially perpendicular to the scan lines. The horizontal portions are substantially parallel to the scan lines. The first vertical portion and the second vertical portion are alternately arranged. Each first vertical portion is connected to its neighboring second vertical portion by a corresponding horizontal portion. The pixel array includes a plurality of pixel units. The length of each horizontal portion is equal to the width of at least one pixel unit. The polarities of signals received by the pixel units on two sides of each horizontal portion are different.

According to a second aspect of the present invention, a display method applicable to the LCD is provided. The display method includes the following steps. A plurality of scan lines, a plurality of data lines, a plurality of switch and a pixel array are provided. Each data line has a plurality of first vertical portions, a plurality of second vertical portions and a plurality of horizontal portions. The first vertical portions and the second vertical portions are substantially perpendicular to the scan lines. The horizontal portions are substantially parallel to the scan lines. The first vertical portions and the second vertical portions are alternately arranged. Each first vertical portion is connected to its neighboring second vertical portion by a corresponding horizontal portion. The length of each horizontal portion is equal to the width of at least one pixel unit. The signals with opposite polarities are received by the pixel units on two sides of each horizontal portion. The pixel array includes a plurality of pixel units. Each pixel unit includes a plurality of corresponding switches. Each scan line provides a driving signal to the corresponding switches. Each odd-column data line provides a first signal to a corresponding first switch group. Each even-column data line provides a second signal to a corresponding second switch group. The first signal and the second signal have opposite polarities. A frame is outputted by way of two-line inversion.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a liquid crystal display frame mode driven by way of column inversion;

FIG. 2 shows a schematic diagram of a liquid crystal display frame mode driven by way of two-line inversion;

FIG. 3A shows a schematic diagram of a LCD according to a first embodiment of the invention;

FIG. 3B shows a schematic diagram of a LCD according to a second embodiment of the invention;

FIG. 3C shows a schematic diagram of a LCD according to a third embodiment of the invention

FIG. 4A shows a layout diagram of a LCD according to a first embodiment of the invention;

FIG. 4B shows a layout diagram of a LCD according to a second embodiment of the invention;

FIG. 4C shows a layout diagram of a LCD according to a third embodiment of the invention;

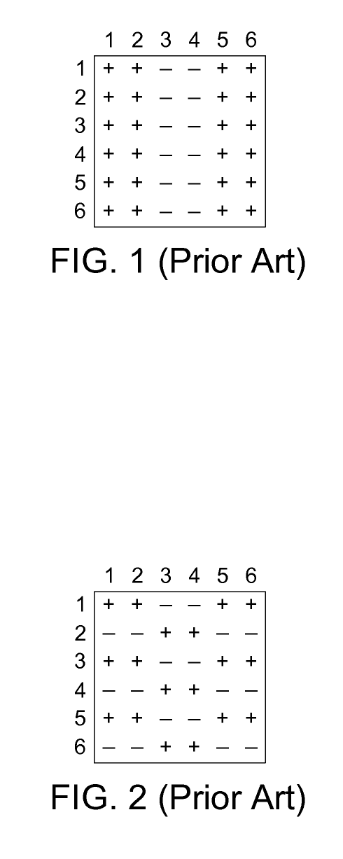

To facilitate the elaboration of the invention, the relative dimensions and scales of some elements of the above drawings may be enlarged or reduced and are not based on actual dimensions or scales.

### DETAILED DESCRIPTION OF THE INVENTION

The invention is related to a liquid crystal display (LCD) and a display method thereof. A driving voltage with the column inversion mode is provided to the pixel array through the data lines. According to the LCD and the display method thereof of the invention, the data lines are correspondingly bending around plural columns of pixel units. As a result, the pixel array may display a frame with a two-line inversion mode effect when responding to the driving voltage with the column inversion mode.

### First Embodiment

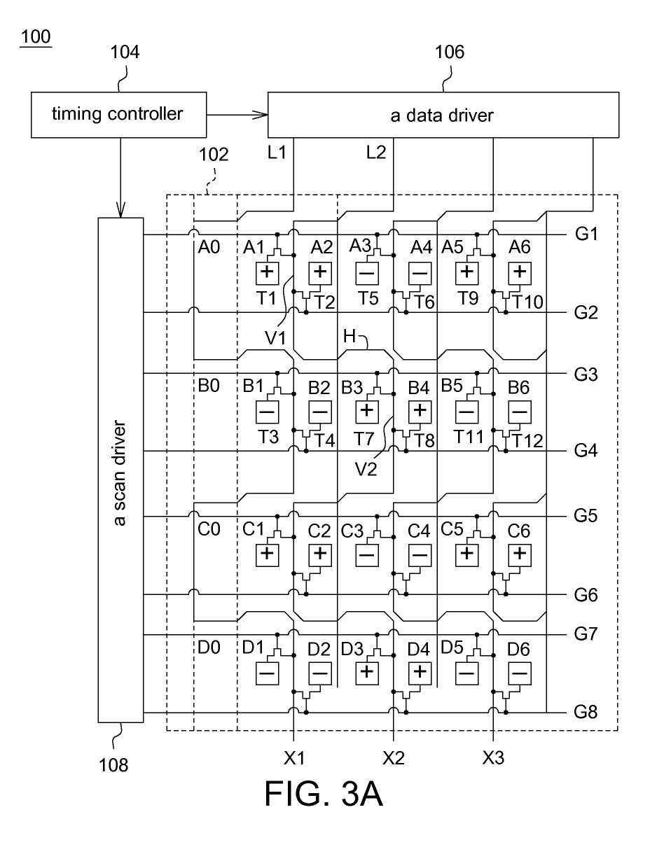

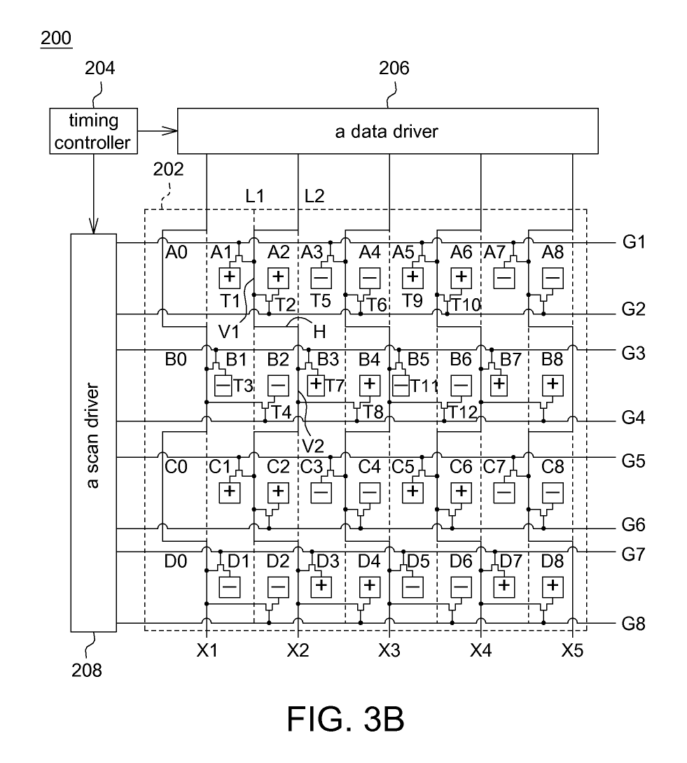

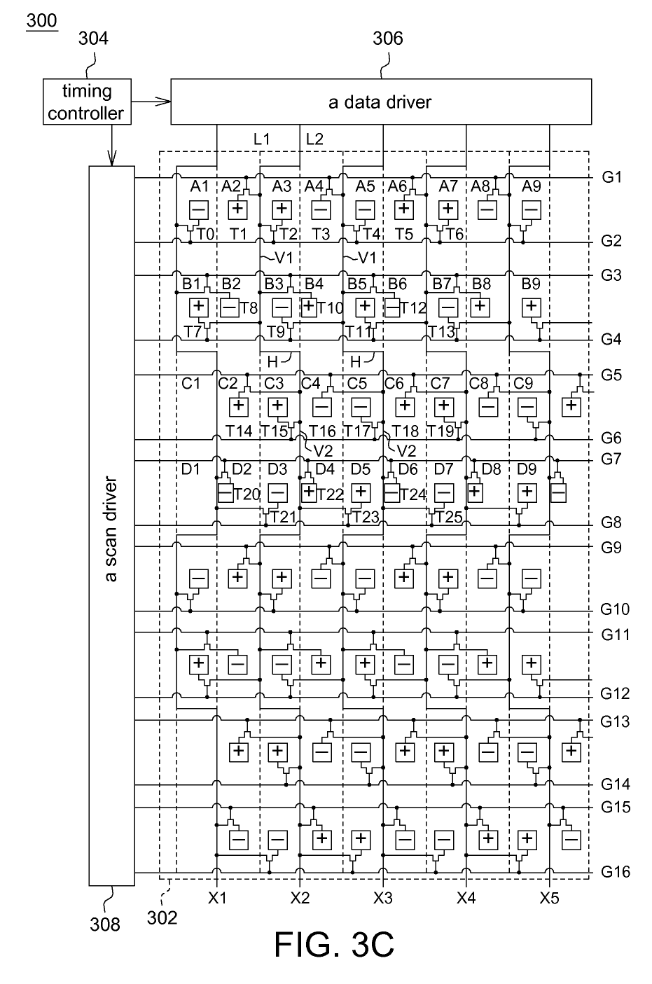

Referring to FIG. 3A, a schematic diagram of a LCD according to a first embodiment of the invention is shown. The LCD 100 includes a plurality of data lines X1˜X3, a plurality of scan lines G1˜G8, a pixel array 102, a timing controller 104, a data driver 106 and a scan driver 108. The scan lines G1˜G8, coupled to the scan driver 108, include a plurality of pairs of dual-gate scan line such as dual-gate scan lines G2 and G3. The dual-gate scan lines G2 and G3 respectively are used for controlling corresponding switches T2 and T3. The data lines X1˜X3 are coupled to the data driver 106. The scan driver 108 and the data driver 106 are coupled to the timing controller 104.

As indicated in FIG. 3A, the pixel array 102 includes a plurality of pixel units. The data lines X1˜X3 are disposed between and bending around a plurality of columns of pixel units. Each of the data lines X1˜X3 has a plurality of first vertical portions V1, a plurality of second vertical portions V2 and a plurality of horizontal portions H. The first vertical portions V1 and the second vertical portions V2 substantially are perpendicular to the scan lines G1˜G8. The horizontal portions H substantially are parallel to the scan lines G1˜G8. The first vertical portions V1 and the second vertical portions V2 are alternately arranged along the direction perpendicular to the scan lines G1˜G8. The first vertical portions V1 may be disposed along a first virtual line L1. The second vertical portions V2 may be disposed along a second virtual line L2. Each first vertical portion V1 is connected to its neighboring second vertical portion V2 by a corresponding horizontal portion H. The first virtual line L1 and the second virtual line L2 do not really exist in the LCD 100. The first virtual line L1 and the second virtual line L2 are defined just for the convenience of elaboration. The first vertical portions V1 and the second vertical portions V2 are connected by the horizontal portions H. The extending direction of the second vertical portion and that of the first vertical portion are separated by a distance equal to the length of the horizontal portion. Besides, each pixel unit includes a switch. Each pixel unit is electrically connected to the corresponding scan line and the corresponding first vertical portion V1 or second vertical portion V2 of the corresponding data line through the corresponding switch. For example, the first vertical portion V1 of the data line X2 connects a corresponding first pair of switches (such as switches T1 and T2). The two switches of the first pair of switches are adjacent to each other and are respectively located on two opposite sides of the first vertical portion V1. The second vertical portion V2 of the data line X2 connects a corresponding second pair of switches (such as switches T7 and T8). The two switches of the second pair of switches are adjacent to each other and are respectively located on two opposite sides of each second vertical portion V2. Thus, the pixel unit A1 is connected to the corresponding first vertical portion V1 of the corresponding data line X2 and the corresponding scan line G1 through the corresponding switch T1. The pixel units A2 is connected to the corresponding first vertical portion V1 of the corresponding data line X2 and the corresponding scan line G2 through the corresponding switch T2. Similarly, the pixel unit B3 is connected to the corresponding second vertical portion V2 of the corresponding data line X2 and the corresponding scan line G3 through the corresponding switch T7. The pixel unit B4 is connected to the corresponding second vertical portion V2 of the corresponding data line X2 and the corresponding scan line G4 through the corresponding switch T8.

In the present embodiment, the first virtual line L1 and the second virtual line L2 are separated from each other by a distance substantially equal to the width of two pixel units. The length of each first vertical portion and that of each second vertical portion are substantially equal to the length of a pixel unit. The length of each horizontal portion is substantially equal to the width of two pixel units. For example, for the data line X2, the length of the first vertical portion V1 and that of the second vertical portion V2 substantially are equal to the length of a pixel unit A1 and the length of a pixel unit B3 respectively. For the data line X2, the length of the horizontal portion H is substantially equal to the width of two pixel units (such as pixel units A2 and A3).

For the pixel array 102 of FIG. 3A, the data lines X1˜X3 drive the pixel array 102 by way of column inversion. Therefore, the signals with the same polarity are provided by the first vertical portion V1 and the second vertical portion V2 of the same data line, but the signals with opposite polarities are provided by two neighboring data lines. For example, the signals provided by the data line X2 and the signals provided by the data line X3 have opposite polarities. That is, the data line X2 provides a first signal to the corresponding switches T1, switches T2, switches T7 and switches T8. The data line X3 provides a second signal to the corresponding switches T5, switches T6, switches T11 and switches T12. The polarity of the first signal and that of the second signal are different. Due to the specific configuration and layout of the data lines X1˜X3, the signals with opposite polarities are received by the pixel units on two sides of each horizontal portion. Therefore, a frame displayed by way of two-line inversion is outputted.

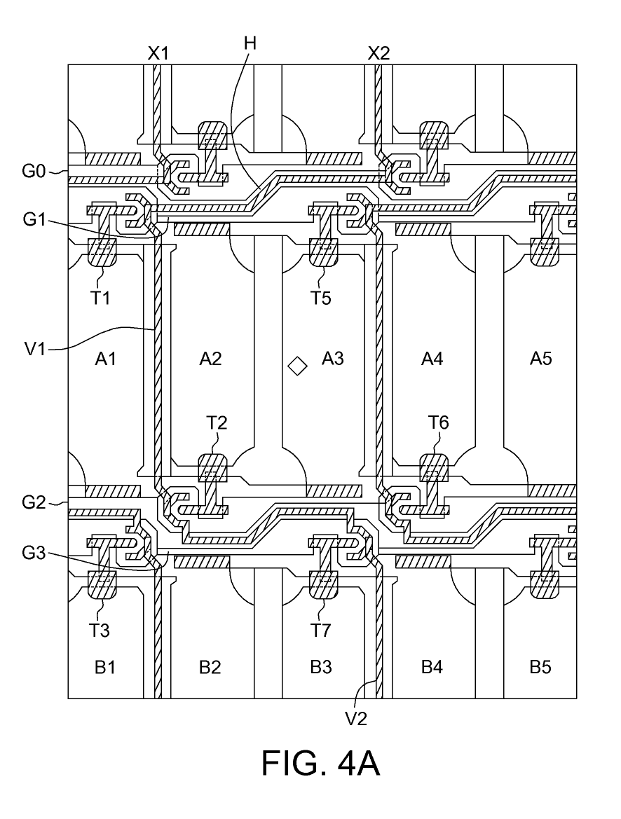

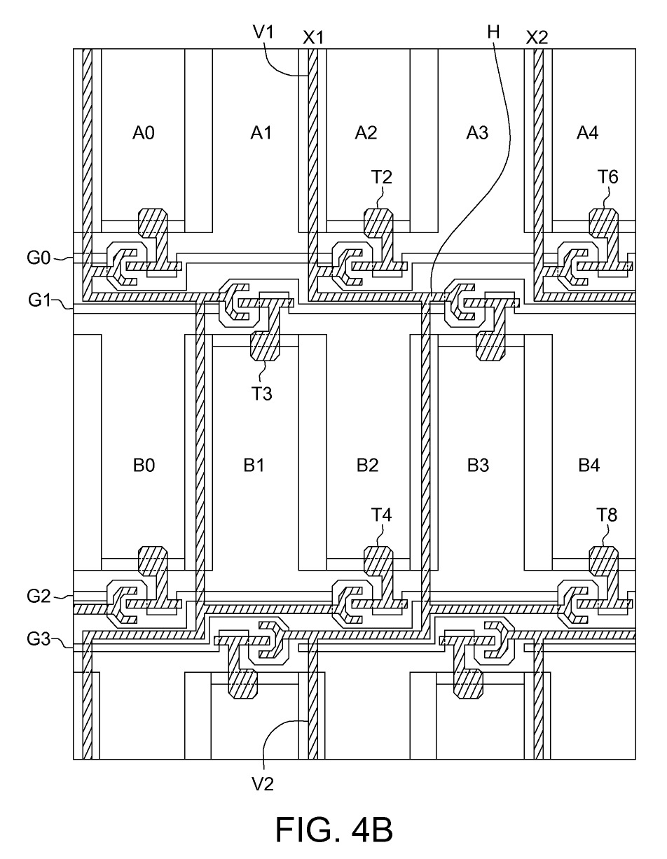

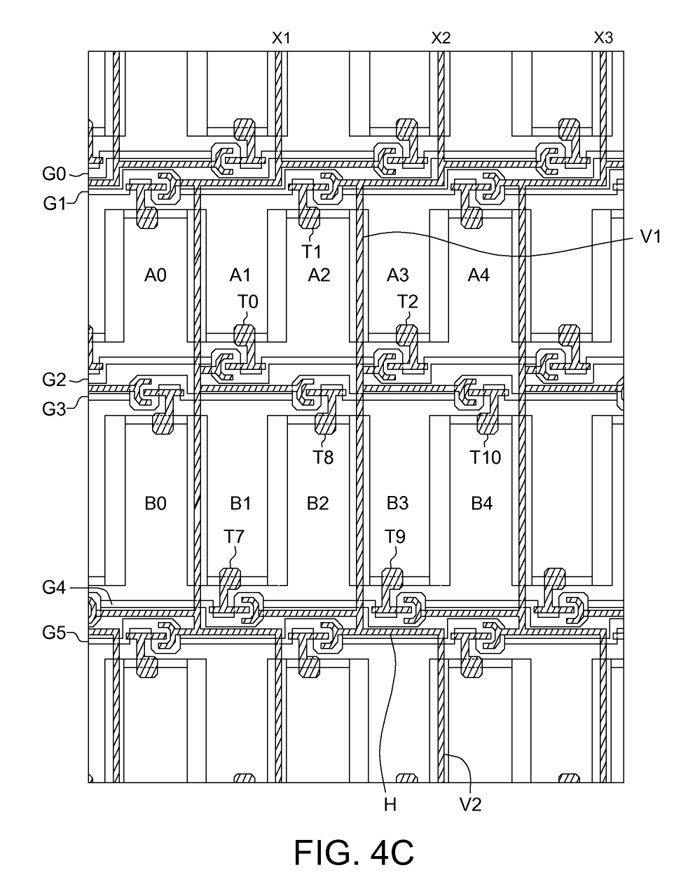

Referring to FIG. 4A, a layout diagram of a LCD according to a first embodiment of the invention is shown. As indicated in FIG. 4A, the horizontal portion H of each data line passes through the part between a pair of dual-gate scan lines (such as scan lines GO and G1). Moreover, the intersection between the first vertical portion and the horizontal portion of a data line and the intersection between the second vertical portion and the horizontal portion of a neighboring data line are separated by a distance smaller than the width of a pixel unit to avoid short-circuiting between neighboring data lines.

### Second Embodiment

Referring to FIG. 3B, a schematic diagram of a LCD according to a second embodiment of the invention is shown. Detailed descriptions of the present embodiment are omitted, and only the differences with the first embodiment are disclosed. In the second embodiment, each pixel unit is electrically connected to a corresponding scan line through the corresponding switch, and is electrically connected to the corresponding first vertical portion V1 or the second vertical portion V2 of a corresponding data line through the corresponding switch. For example, a first vertical portion V1 of the data line X2 connects the corresponding first pair of switches (such as switch T1 and switch T2). The switches of the first pair of switches are adjacent to each other and are respectively located on two opposite sides of the first vertical portion V1. A second vertical portion V2 of the data line X2 connects the the corresponding second pair of switches (such as switch T7 and switch T8). The switches of the second pair of switches are adjacent to each other and are located on the same side of the second vertical portion V2. Thus, the pixel unit A1 is connected to the corresponding first vertical portion V1 of the corresponding data line X2 and the corresponding scan line G1 through the corresponding switch T1. The pixel unit A2 is connected to the corresponding first vertical portion V1 of the corresponding data line X2 and the corresponding scan line G2 through the corresponding switch T2. Similarly, the pixel unit B3 is connected to the corresponding second vertical portion V2 of the corresponding data line X2 and the corresponding scan line G3 through the corresponding switch T7. The pixel unit B4 is connected to the corresponding second vertical portion V2 of the corresponding data line X2 and the corresponding scan line G4 through the corresponding switch T8.

As indicated in FIG. 3B, in the present embodiment, the first virtual line L1 and the second virtual line L2 are separated from each other by a distance substantially equal to the width of a pixel unit. The length of each first vertical portion and that of each second vertical portion are substantially equal to the length of a pixel unit. The length of each horizontal portion is substantially equal to the width of a pixel unit. For example, for the data line X2, the length of the first vertical portion V1 and that of the second vertical portion V2 are substantially equal to the length of a pixel unit A1 and the length of a pixel unit B2. For the data line X2, the length of the horizontal portion H is substantially equal to the width of a pixel unit (such as pixel unit A2).

The data lines X1˜X5 drive the pixel array 202 by way of column inversion. Therefore, the signals provided by the first vertical portion V1 and the second vertical portion V2 of the same data line have the same polarity, but the signals provided by two neighboring data lines have opposite polarities. For example, the signals provided by the data lines X2 and X3 have opposite polarities. That is, the data line X2 provides a first signal to the corresponding switches T1, T2, T7 and T8. The data line X3 provides a second signal to the corresponding switches T5, T6, T11 and T12. The first signal and the second signal have opposite polarities. Due to the specific configuration and layout of the data lines X1˜X5, the signals with opposite polarities are received by the pixel units on two sides of each horizontal portion. Therefore, a frame displayed by way of two-line inversion output is outputted.

Referring to FIG. 4B, a layout diagram of a LCD according to a second embodiment of the invention is shown. As indicated in FIG. 4B, the horizontal portion H of each data line passes through the part between a pair of dual-gate scan lines (such as scan lines G0 and G1). Moreover, the intersection between the first vertical portion and the horizontal portion of a data line and the intersection between the second vertical portion and the horizontal portion of a neighboring data line are separated by a distance smaller than the width of a pixel unit.

### Third Embodiment

Referring to FIG. 3C, a schematic diagram of a LCD according to a third embodiment of the invention is shown. Detailed descriptions of the present embodiment are omitted, and only the differences with the first or the second embodiment are disclosed. In the third embodiment, each pixel unit is electrically connected to the corresponding scan line through the corresponding switch, and is electrically connected to the corresponding first vertical portion V1 or second vertical portion V2 of the corresponding data line through the corresponding switch.

For example, the first vertical portion V1 of the data line X2 connects the corresponding first pair of switches (such as switch T1 and switch T2) and the corresponding second pair of switches (such as switches T7 and T10). The switches of the first pair of switches are adjacent to each other and are respectively located on two opposite sides of the first vertical portion V1. The switches of the second pair of switches are separated from each other by a distance substantially equal to the width of two pixel units, and are located on two opposite sides of the first vertical portion V1.

The second vertical portion V2 of the data line X2 connects the corresponding third pair of switches (such as switches T14 and T15) and the corresponding fourth pair of switches (such as switches T22 and T23). The switches of the third pair of switches are adjacent to each other and are located on the first side of the second vertical portion V2. The switches of the fourth pair of switches are adjacent to each other and are located on the second side (opposite to the first side) of the second vertical portion V2.

For example, the pixel unit A2 is connected to the corresponding first vertical portion V1 of the corresponding data line X2 and the corresponding scan line G1 through the corresponding switch T1. The pixel unit A3 is connected to the corresponding first vertical portion V1 of the corresponding data line X2 and the corresponding scan line G2 through the corresponding switch T2. The pixel unit B1 is connected to the corresponding first vertical portion V1 of the corresponding data line X2 and the corresponding scan line G4 through the corresponding switch T7. The pixel unit B4 is connected to the corresponding first vertical portion V1 of the corresponding data line X2 and the corresponding scan line G3 through the corresponding switch T10.

Similarly, the pixel unit C2 is connected to the corresponding second vertical portion V2 of the corresponding data line X2 and the corresponding scan line G5 through the corresponding switch T14. The pixel unit C3 is connected to the corresponding second vertical portion V2 of the corresponding data line X2 and the corresponding scan line G6 through the corresponding switch T15. The pixel units D4 is connected to the corresponding second vertical portion V2 of the corresponding data line X2 and the corresponding scan line G7 through the corresponding switch T22. The pixel unit D5 is connected to the corresponding second vertical portion V2 of the corresponding data line X2 and the corresponding scan line G8 through the corresponding switch T23.

As indicated in FIG. 3C, in the present embodiment, the first virtual line L1 and the second virtual line L2 are separated from each other by a distance substantially equal to the width of a pixel unit. The length of each first vertical portion V1 and that of each second vertical portion V2 are substantially equal to the length of two pixel units. The length of each horizontal portion is substantially equal to the width of a pixel unit. For example, for the data line X2, the length of the first vertical portion V1 is equal to the length of two pixel units (such as pixel units A2 and B2), and the length of the second vertical portion V2 is equal to the length of two pixel units (such as pixel units C3 and D3). For the data lines X2, the length of the horizontal portions H is equal to the width of a pixel unit B3.

The data lines X1˜X5 drive the pixel array 302 by way of column inversion. Therefore, the signals with the same polarity are provided by the first vertical portion V1 and the second vertical portion V2 of the same data line, but the signals with opposite polarities are provided by two neighboring data lines. That is, the data line X2 provides a first signal to the corresponding switches T1, T2, T7, T10, T14, T15, T22 and T23. The data line X3 provides a second signal to the corresponding switches T3, T4, T9, T12, T16, T17, T24 and T25. The first signal and the second signal have different polarities. Due to the specific configuration and layout of the data lines X1˜X5, the signals with different polarities are received by the pixel units on two sides of each horizontal portion. Therefore, a frame displayed by way of two-line inversion is outputted.

Referring to FIG. 4C, a layout diagram of a LCD according to a third embodiment of the invention is shown. As indicated in FIG. 4C, the horizontal portion H of each data line passes through the part between a pair of dual-gate scan lines (such as scan lines G0 and G1). Moreover, the intersection between the first vertical portion and the horizontal portion of a data line and the intersection between the second vertical portion and the horizontal portion of a neighboring data line are separated by a distance smaller than the width of a pixel unit.

According to the LCD and the display method thereof disclosed in above embodiments of the invention, the LCD pixel array is driven by way of column inversion to save the power consumption for driving the LCD. Moreover, through the configuration and layout of periodically bending data lines as well as the connection relationships between each pixel unit and its switches and the corresponding data lines and the corresponding scan lines, the first vertical portion V1 and the second vertical portion V2 of a data line provides a signal data to a neighboring pixel unit. Thus, the LCD pixel array responds to the column inversion mode driving voltage provided by the data line and displays an image with an effect of two-line inversion. In comparison to the conventional LCD, the LCD and the display method thereof of the invention have the advantage of achieving higher frame display quality with lower power consumption.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display, comprising:
a plurality of scan lines;
a plurality of data lines each having a plurality of first vertical portions, a plurality of second vertical portions and a plurality of horizontal portions, wherein the first vertical portions and the second vertical portions are substantially perpendicular to the scan lines, the horizontal portions are substantially parallel to the scan lines, the first vertical portions and the second vertical portions are alternately arranged, and each first vertical portion is connected to its neighboring second vertical portion by the corresponding horizontal portion; and
a pixel array comprising a plurality of pixel units,
wherein, a length of each horizontal portion is equal to a width of at least one pixel unit, signals with different polarities are received by the pixel units on two sides of each of the horizontal portions.

2. The liquid crystal display according to claim 1, wherein, the pixel units comprise a plurality of corresponding switches, each pixel unit is electrically connected to the corresponding scan line and the corresponding first or the corresponding second vertical portion of the corresponding data line through the corresponding switch, a length of each of the first vertical portions and a length of each of the second vertical portions are respectively equal to a length of a pixel unit, and the length of each of the horizontal portions is equal to a width of two pixel units.

3. The liquid crystal display according to claim 2, wherein each first vertical portion connects a first pair of switches of the corresponding switches, the two switches of the first pair of switches are adjacent to each other and are respectively located on two opposite sides of the each first vertical portion, each second vertical portion connects a corresponding second pair of switches of the corresponding switches, and two switches of the second pair of switches are adjacent to each other and are respectively located on two opposite sides of the each second vertical portion.

4. The liquid crystal display according to claim 1, wherein, the pixel units comprise a plurality of corresponding switches, each pixel unit is electrically connected to the corresponding scan line and the corresponding first or the corresponding second vertical portion of the corresponding data line through the corresponding switch, a length of each of the first vertical portions and a length of each of the second vertical portions are respectively equal to a length of a pixel unit, and the length of each horizontal portion is equal to a width of the one pixel unit.

5. The liquid crystal display according to claim 4, wherein each first vertical portion connects a first pair of switches of the corresponding switches, the two switches of the first pair of switches are adjacent to each other and are respectively located on two opposite sides of the each first vertical portion, each second vertical portion connects a second pair of switches of the corresponding switches, and two switches of the second pair of switches are adjacent to the each second vertical portion and are located on a same side of each second vertical portion.

6. The liquid crystal display according to claim 1, wherein, the pixel units comprise a plurality of corresponding switches, each of the pixel units is electrically connected to the corresponding scan line and the corresponding first or the corresponding second vertical portion of the corresponding data line through the corresponding switch, a length of each first vertical portion and a length of each of the second vertical portions are respectively equal to a length of two pixel units, and the length of each of the horizontal portions is equal to the width of the one pixel unit.

7. The liquid crystal display according to claim 6, wherein each first vertical portion connects a first group of switches of the corresponding switches, the first group of switches comprises a first pair of switches and a second pair of switches, the two switches of the first pair of switches are adjacent to each other and are respectively located on two opposite sides of the each first vertical portion, the two switches of the second pair of switches are separated from each other by two pixel units and are respectively located on two opposite sides of the each second vertical portion, and the first pair of switches and the second pair of switches are located on two stacking rows respectively;
wherein, the each second vertical portion connects a corresponding second group of switches of the corresponding switches, the second group of switches comprises a third pair of switches and a fourth pair of switches, the third pair of switches is adjacent to the each second vertical portion, the two switches of the third pair of switches are adjacent to each other and are located on one side of the each second vertical portion, the fourth pair of switches is adjacent to the each second vertical portion, the two switches of the fourth pair of switches are adjacent to each other and are located on another side of the each second vertical portion, and the third pair of switches and the fourth pair of switches are located on two stacking rows respectively.

8. The liquid crystal display according to claim 2, wherein the signals with opposite polarities are provided by two neighboring first vertical portions, the signals with opposite polarities are provided by two neighboring second vertical portions, and the signals with the same polarity are provided by the first vertical portion and the second vertical portion of each data line.

9. The liquid crystal display according to claim 2, wherein, the scan lines comprise a plurality of pairs of dual-gate scan lines for controlling the corresponding switches.

10. The liquid crystal display according to claim 9, wherein the neighboring switches of the corresponding switches on the same column are controlled by different scan lines, and the neighboring switches of the corresponding switches on the same row are controlled by different scan lines.

11. The liquid crystal display according to claim 9, wherein the each horizontal portion passes through a part between the scan lines of the each pair of the dual-gate scan lines.

12. A display method applicable to the liquid crystal display, wherein the method comprises:
providing a plurality of scan lines, a plurality of data lines, a plurality of switch and a pixel array, wherein each data line has a plurality of first vertical portions, a plurality of second vertical portions and a plurality of horizontal portions, the first vertical portions and the second vertical portions are substantially perpendicular to the scan lines, the horizontal portions are substantially parallel to the scan lines, the first vertical portions and the second vertical portions are alternately arranged, the first vertical portion is connected to its neighboring second vertical portion by the corresponding horizontal portion, a length of each horizontal portion is equal to a width of at least one pixel unit, the pixel array comprises a plurality of pixel units, signals with opposite polarities are received by the pixel units on two sides of the each horizontal portion, and the pixel units comprise a plurality of corresponding switches;
providing a driving signal from each of the scan lines to the corresponding switches;
providing a first signal from each of the odd-column data lines to a corresponding first group of switches, providing a second signal from each of the even-column data lines to a corresponding second group of switches, the first signal and the second signal have different polarities; and
outputting a frame displayed with an effect of two-line inversion.

13. The display method according to claim 12, wherein a length of each of the first vertical portions and a length of each of the second vertical portions are respectively equal to a length of one pixel unit, each of the pixel units is electrically connected to the corresponding scan line and the corresponding data line through the corresponding switch, the first group of switches comprises a first pair of switches and a second pair of switches, the second group of switches comprises a third pair of switches and a fourth pair of switches, the first pair of switches and the third pair of switches are located on a first row, and the second pair of switches and the fourth pair of switches are located on a second row adjacent to the first row.

14. The display method according to claim 13, wherein, the length of each of the horizontal portions is equal to the width of the one pixel unit, the two switches of the first pair of switches are adjacent to each other and located on two opposite sides of each first vertical portion, the two switches of the second pair of switches are adjacent to each other and located on one side of each second vertical portion, and the second pair of switches is adjacent to the second vertical portion.

15. The display method according to claim 13, wherein the length of each horizontal portion is equal to a width of two pixel units, the two switches of the first pair of switches are adjacent to each other and located on two opposite sides of the each first vertical portion, and two switches of the second pair of switches are adjacent to each other and located on two opposite sides of the each second vertical portion.

16. The display method according to claim 12, wherein a length of each first vertical portion and a length of each second vertical portion are respective equal to a length of two pixel units, the length of each horizontal portion is equal to a width of a pixel unit, each pixel unit is electrically connected to the corresponding scan line and the corresponding first vertical portion or the corresponding second vertical portion of the corresponding data line through the corresponding switch.

17. The display method according to claim 16, wherein the first group of switches comprises a first pair of switches, a second pair of switches, a third pair of switches and a fourth pair of switches, the second group of switches comprises a fifth pair of switches, a sixth pair of switches, a seventh pair of switches and an eighth pair of switches, the first pair of switches and the fifth pair of switches are located on a first row, the second pair of switches and the sixth pair of switches are located on a second row, the third pair of switches and the seventh pair of switches are located on a third row, the fourth pair of switches and the eighth pair of switches are located on a fourth row, and the first row, the second row, the third row and the fourth row are arranged in order.

18. The display method according to claim 17, wherein the two switches of the first pair of switches are adjacent to each other and are located on two opposite sides of the first vertical portion, the two switches of the second pair of switches are separated from each other by two pixel units and are located on two opposite sides of the first vertical portion, the two switches of the third pair of switches are adjacent to each other and are located on one side of the second vertical portion, the third pair of switches is adjacent to the second vertical portion, the two switches of the fourth pair of switches are adjacent to each other and are located on another side of the second vertical portion, and the fourth pair of switches is adjacent to the second vertical portion.

19. The display method according to claim 14, wherein the data lines are driven by a timing controller by way of column inversion, and the scan lines outputting the driving signal to control the switches by dual-gate scan lines.

20. The display method according to claim 19, wherein the neighboring switches of the same column are controlled by different scan lines, and the neighboring switches of the same row are controlled by different scan lines.
